(19) United States
(12) Patent Application Publication
(10) Pub. No.: US 2026/0336442 A1
(43) Pub. Date: Oct. 29, 2026

(54) ADAPTABLE DIRECT CURRENT FAST CHARGING SWITCH BOX FOR ELECTRIFIED VEHICLES

(71) Applicant: GM GLOBAL TECHNOLOGY OPERATIONS LLC, Detroit, MI (US)

(72) Inventors: Nomar S. GONZALEZ SANTINI, Lakeland, FL (US); Armando Antoniio Beltran Pacheco, Rochester Hills, MI (US); Jaideep Singh, West Bloomfield, MI (US); Azeem Sarwar, Rochester Hills, MI (US)

(21) Appl. No.: 19/247,378

(22) Filed: Jun. 24, 2025

Related U.S. Application Data
(63) Continuation-in-part of application No. 19/187,086, filed on Apr. 23, 2025, now Pat. No. 12,780,016.

(51) Int. Cl. B60L 53/22; B60L 53/10; B60L 53/16

(52) U.S. Cl. CPC B60L 53/22; B60L 53/11; B60L 53/16; B60L 2210/10; B60L 2210/30

(57) ABSTRACT

A switch box includes a first port removably connected to a charging port of a vehicle and a second port removably connected to a charger. First ends of a first conductor, a second conductor, a third conductor, and a fourth conductor are arranged in the first port. Second ends of the first conductor and the fourth conductor arranged in the second port. A first switch is configured to selectively connect the first conductor to the third conductor. A second switch is configured to selectively connect the second conductor to the fourth conductor. A switch configuration circuit is configured to receive switch configuration data from at least one of the vehicle and the charger and to control states of the first switch and the second switch in response to the switch configuration data.

### CROSS-REFERENCE TO RELATED APPLICATIONS

The present disclosure is a continuation-in-part of United States Patent Application No. 19/187,086 filed on Apr. 23, 2025. The entire disclosure of the application referenced above are incorporated herein by reference.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to switch boxes for electric vehicles, and more particularly to an adaptable switch box for direct current fast charging (DCFC) of electric vehicles.

Electrified vehicles (EVs) such as battery electric vehicles (BEVs), hybrid vehicles, and/or fuel cell vehicles include one or more electric machines and a rechargeable energy storage system (RESS) including one or more battery cells, modules, and/or packs. A power control system is used to control charging and/or discharging of the battery system during charging and/or driving.

### SUMMARY

A switch box includes a first port removably connected to a charging port of a vehicle and a second port removably connected to a charger. First ends of a first conductor, a second conductor, a third conductor, and a fourth conductor are arranged in the first port. Second ends of the first conductor and the fourth conductor arranged in the second port. A first switch is configured to selectively connect the first conductor to the third conductor. A second switch is configured to selectively connect the second conductor to the fourth conductor. A switch configuration circuit is configured to receive switch configuration data from at least one of the vehicle and the charger and to control states of the first switch and the second switch in response to the switch configuration data.

In other features, the switch box includes a third switch including a first terminal connected to a first end of a fifth conductor, wherein the fifth conductor includes a second end in the second port, a second terminal connected to a first end of a sixth conductor, wherein the sixth conductor includes a second end in the second port, and a third terminal connected to the fourth conductor. The third switch is configured to selectively connect the first terminal of the third switch one of the second terminal of the third switch and the third terminal of the third switch.

In other features, the switch configuration circuit is configured to control a state of the third switch in response to the switch configuration data. A control conductor includes a first end arranged in the first port and a second end arranged in the second port and configured to supply the switch configuration data to the switch configuration circuit.

In other features, a fourth switch includes a first terminal connected to the second conductor and a second terminal connected to the sixth conductor. The fourth switch is configured to selectively connect the first terminal of the fourth switch to the second terminal of the fourth switch. The switch configuration circuit is configured to control a state of the fourth switch in response to the switch configuration data. A converter is configured to supply power to the switch configuration circuit.

In other features, a first end of a seventh conductor is arranged in the first port and a second end of the seventh conductor is arranged in the second port. The seventh conductor carries a reference potential.

A vehicle includes the charging port, the switch box. The first port of the switch box is removably connected to the charging port. A first HV bus is selectively connected to the first and second conductors, a first rechargeable energy storage system (RESS) selectively connected between the first and second conductors, and a first load selectively connected between the first and second conductors. A second HV bus is selectively connected to the third and fourth conductors, a second RESS selectively connected between the third and fourth conductors, and a second load selectively connected between the third and fourth conductors. An onboard charging module (OBCM) is configured to charge at least one of the first RESS and the second RESS using an alternating current (AC). A plurality of switches is configured to selectively connect at least two of the first conductor, the second conductor, the third conductor, and the fourth conductor to the OBCM. A controller is configured to control the plurality of switches in response to the switch configuration data.

In other features, the OBCM includes a first OBCM connected to the first RESS and a second OBCM connected to the second RESS. The plurality of switches is configured to selectively connect the first conductor and the second conductor to the first OBCM and the third conductor and the fourth conductor to the second OBCM.

A vehicle includes a first HV bus selectively connected to a first conductor and a second conductor, a first rechargeable energy storage system (RESS) selectively connected between the first conductor and the second conductor, and a first load selectively connected between the first conductor and second conductor. A second HV bus is selectively connected to a third conductor and a fourth conductor, a second RESS selectively connected between the third and fourth conductors, and a second load selectively connected between the third conductor and the fourth conductor. A first switch is selectively connecting the first conductor to the third conductor. A second switch selectively connects the second conductor to the fourth conductor. A third switch includes a first terminal connected to a first end of a fifth conductor, a second terminal connected to a first end of a sixth conductor, and a third terminal connected to the fourth conductor. The third switch is configured to selectively connect the first terminal of the third switch to one of the second terminal of the third switch and the third terminal of the third switch. The first conductor, the second conductor, the fifth conductor and the sixth conductor are configured to connect to a charger.

In other features, a fourth switch includes a first terminal connected to the second conductor and a second terminal connected to the sixth conductor. The fourth switch is configured to selectively connect the first terminal of the fourth switch to the second terminal of the fourth switch. A switch configuration circuit is configured to receive switch configuration data and to control states of the first switch, the second switch, and the third switch based thereon.

In other features, a converter is configured to supply power to the switch configuration circuit. A seventh conductor carries a reference potential for the switch configuration circuit. An eighth conductor carries control signals including the switch configuration data for the switch configuration circuit.

In other features, a plurality of switches is configured to selectively connect at least two of the first conductor, the second conductor, the third conductor, and the fourth conductor to an onboard charging module (OBCM) connected to at least one of the first HV bus and the second HV bus. The switch configuration circuit is configured to control the plurality of switches in response to the switch configuration data.

In other features, the OBCM includes a first OBCM connected to the first RESS and a second OBCM connected to the second RESS. The plurality of switches is configured to selectively connect the first conductor and the second conductor to the first OBCM and the third conductor and the fourth conductor to the second RESS.

A direct current fast charger (DCFC) for a vehicle includes a first conductor, a second conductor, a third conductor, a fourth conductor, a fifth conductor, and a sixth conductor. The first conductor, the second conductor, the third conductor, and the fourth conductor are selectively connected to the vehicle. A first alternating current/direct current (AC/DC) converter is configured to convert AC power to DC power output on the first conductor and the fifth conductor. A second AC/DC converter is configured to convert AC power to DC power output on the fourth conductor and the sixth conductor. The first conductor, the fourth conductor, the fifth conductor and the sixth conductor are selectively connected to at least one of the first AC/DC converter and the second AC/DC converter. A first switch is configured to selectively connect the first conductor to the third conductor. A second switch is configured to selectively connect the second conductor to the fourth conductor. A third switch includes a first terminal connected to the fifth conductor, a second terminal connected to the sixth conductor, and a third terminal connected to the fourth conductor. The third switch is configured to selectively connect the fifth conductor to one of the fourth conductor and the sixth conductor. A fourth switch is configured to connect the second conductor to the third conductor. A switch configuration circuit is configured to control states of the first switch, the second switch, the third switch, and the fourth switch in response to switch configuration data.

In other features, a fifth switch is configured to connect the second conductor to the sixth conductor. A first DC/DC converter is connected between the first AC/DC converter and the first conductor and the fifth conductor. A second DC/DC converter is connected between the second AC/DC converter and the fourth conductor and the sixth conductor.

Further areas of applicability of the present disclosure will become apparent from the detailed description, the claims, and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a functional block diagram of a high voltage bus and rechargeable energy storage system (RESS) architecture for an electric vehicle;

FIGS. 2A and 2B are functional block diagrams of examples of distributed high voltage bus and hybrid RESS architectures according to the present disclosure;

FIGS. 3 and 4 are functional block diagrams of other examples of distributed high voltage bus and hybrid RESS architectures according to the present disclosure;

FIGS. 5A-8 are functional block diagrams of other examples of distributed high voltage bus and hybrid RESS architectures with modular switch boxes according to the present disclosure;

FIG. 9 is a functional block diagram of a distributed high voltage bus and hybrid RESS architecture for distributed home charging according to the present disclosure;

FIG. 10 is a functional block diagram of an example of a vehicle charging port, a switch box, and a charger according to the present disclosure;

FIG. 11A is a functional block diagram of an example of switches configured to connect an AC source from the charger to an onboard charging module (OBCM) or a DC source directly to first and second RESS associated with first and second HV buses according to the present disclosure;

FIGS. 11B-11E are functional block diagrams of example configurations of the switches of FIG. 11A according to the present disclosure; and

FIGS. 12 and 13 are functional block diagrams of other examples of DCFCs with integrated switch boxes according to the present disclosure.

In the drawings, reference numbers may be reused to identify similar and/or identical elements.

### DETAILED DESCRIPTION

An electric vehicle (EV) include a single bus with two or more rechargeable energy storage systems (RESS) operating at a high voltage (HV) (e.g., 400V). Since the RESS are connected across the same HV bus, the two or more RESS typically use the same battery chemistry and operate at the same voltage level.

In some examples, the two or more RESS can be connected in series between supply and reference HV bus conductors. In other examples, the two or more RESS are connected in parallel between the first and second HV bus conductors. In some examples, a DC-DC converter is connected to the two or more parallel-connected RESS to step up the voltage from one voltage level to another (e.g., from 400V to 800V) to power higher voltage loads (e.g., 800V loads such as an auxiliary power module (APM)).

For example, during 400V direct current fast charging (DCFC) when using an 800V architecture, the 800V loads (such as an 800V auxiliary power module (APM)) may be unable to operate. Since the APM is not operating, devices associated with the APM are unable to power one or more controllers, which may adversely impact vehicle operation. In addition, loads such as electric heaters may derate which adversely impacts cold weather charging and customer satisfaction. Possible solutions include adding a 400V to 800V converter which adds cost and has adverse packaging implications. Utilizing a power inverter and motor as boost converter adds cost, involves complex software, and has adverse packaging implications. Increasing a voltage operating range of the APMs (e.g., from ~ 400V to ~ 800V) is inefficient and costly.

A distributed high voltage (HV) bus and rechargeable energy storage system (RESS) hybrid architecture according to the present disclosure includes two or more HV buses and two or more RESS. More particularly, the number of HB buses that can be formed is equal to 2^{R}-1, where R is the number of independent RESS. Using two or more HV buses allows the HV buses to operate at different voltages which may be advantageous for some types of loads. However, the same voltages can also be used. Using two or more HV buses also enables the use of RESS including battery cells with different battery chemistries. However, the same battery chemistry can also be used.

The architecture described herein enhances efficiency and performance by enabling HV components to operate at a voltage level that is optimum for the particular(s) HV component(s). When one of the RESS has a fault, the architecture described herein reconfigures to enable operation with reduced performance using onboard charging modules. In some examples, the architecture described herein enables direct current (DC) fast charging (DCFC) of each RESS (e.g., multi-port charging) to significantly reduce charging time. The architecture described herein can be connected to a modular switch box implemented either in the vehicle or separately. The switch box can be used to enable different charging functionality.

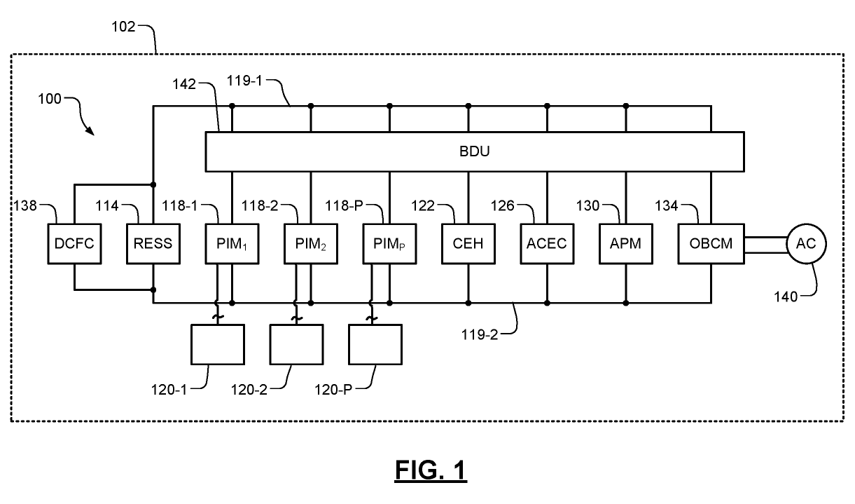

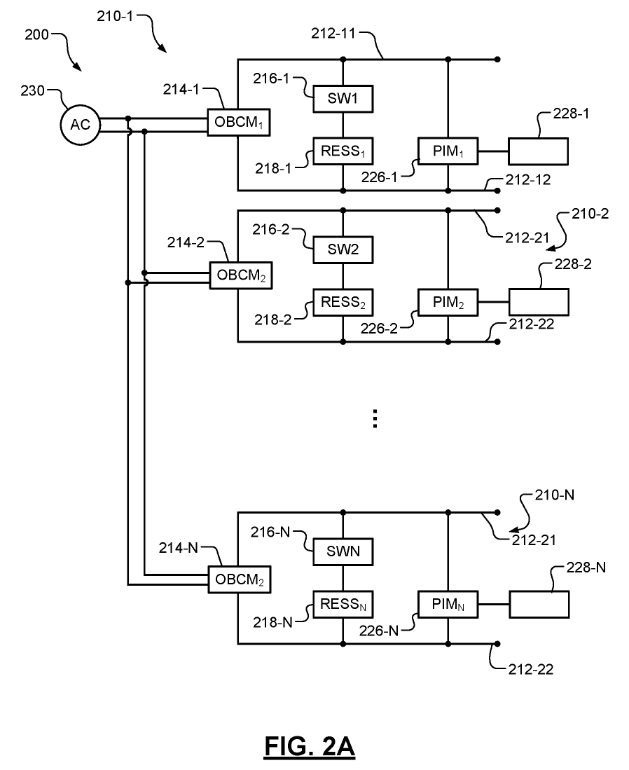

Referring now to FIG. 1, a high voltage bus and rechargeable energy storage system (RESS) architecture 100 is shown for an electric vehicle (EV) 102. N power inverter modules (PIMs) 118-1, 118-2, …, and 118-P are connected between first and second conductors 119-1 and 119-2 corresponding to supply and reference potential, respectively, for a high voltage (HV) bus. The PIMs 118-1, 118-2, …, and 118-P supply power from a rechargeable energy storage system (RESS) 114 to electric machines (motors) 120-1, 120-2, …, and 120-P.

Loads 122, 126, and 130 such as coolant electric heaters (CEH), air conditioning electric compressor (ACEC), and/or auxiliary power modules (APM) are also selectively connected between the conductors 119-1 and 119-2 of the HV bus. An onboard charging module (OBCM) 134 is connected between the conductors 119-1 and 119-2 of the HV bus and to an alternating current (AC) source (e.g., such as an AC charging station. A battery disconnect unit 142 includes an array of switches (not shown) configured to disconnect a respective component from the conductors 119-1 and 119-2 of the HV bus. A direct current fast charging (DCFC) station 138 is selectively connected to the RESS 114.

As can be appreciated, the HV bus and rechargeable energy storage system (RESS) architecture 100 includes a single HV bus common to all of the components. Only one voltage level is shared by all of the components. This architecture has limited DC fast charge (DCFC) capabilities.

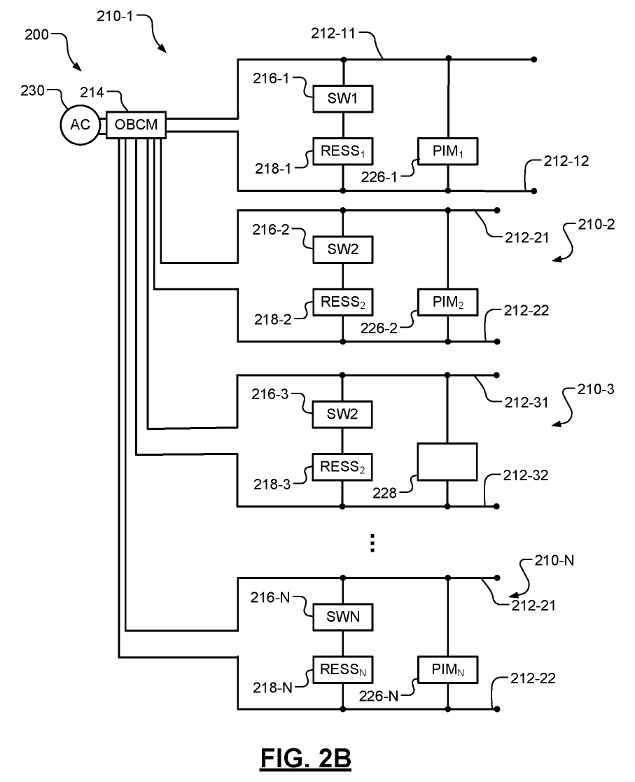

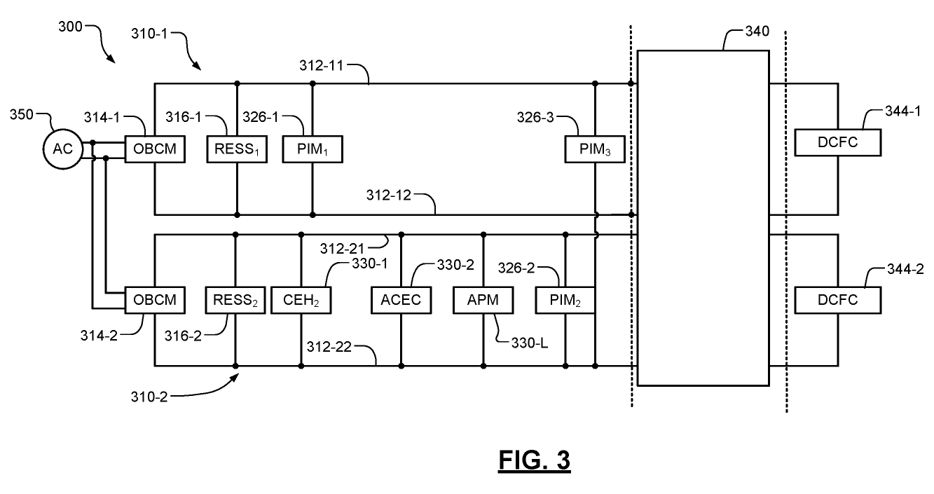

Referring now to FIGS. 2A and 2B, a distributed HV bus and hybrid RESS architecture 200 includes N HV buses 210-1, 210-2, …, and 210-N, where N is an integer greater than one. In FIG. 2A, a first HV bus 210-1 includes conductors 212-11 and 212-12 corresponding to supply and reference potentials, respectively. The first HV bus 210-1 includes an onboard charging module (OBCM) 214-1 connected between the conductors 212-11 and 212-12 and selectively connected to an alternating current (AC) source 230 during AC charging. In some examples, a switch SW1 is connected in series with a first RESS 218-1 between the conductors 212-11 and 212-12 to connect and disconnect the RESS 218-1. As described herein, the switches include a control terminal, a first terminal, and a second terminal. In some examples, the switches may include a third or additional terminals.

The second HV bus 210-2 includes conductors 212-21 and 212-22 corresponding to supply and reference potentials, respectively. The second HV bus 210-2 includes an OBCM 214-2 connected between the conductors 212-21 and 212-22 and selectively connect to the AC source 230. In some examples, a switch SW2 is connected in series with a second RESS 218-2 between the conductors 212-21 and 212-22. The PIM 226-2 supplies power to one or more electric machines or motors 228-2.

The N^{th} HV bus 210-N includes conductors 212-N1 and 212-N2 corresponding to supply and reference potentials, respectively. The N^{th} HV bus 210-N includes an OBCM 214-N connected between the conductors 212-N1 and 212-N2. In some examples, a switch SWN is connected in series with a N^{th} RESS 218-N between the conductors 212-N1 and 212-N2. The PIM 226-N supplies power to one or more electric machines or motors 228-N.

In some examples, the RESS 218-1 includes one or more battery packs, modules, and/or battery cells. In some examples, all of the RESS 218-1 , 218-2, …, and 218-N operate at a high voltage (HV). As used herein, HV refers to voltages greater than or equal to 60V. In some examples, all of the RESS 218-1 , 218-2, …, and 218-N operate at the same voltage (e.g., 100V, 200V, 400V, etc.). In some examples, one or more of the RESS 218-1 , 218-2, …, and 218-N operate at a different voltage than remaining ones of the RESS 218-1 , 218-2, …, and 218-N. In some examples, all of the RESS 218-1 , 218-2, …, and 218-N include battery cells using the same battery chemistry. In some examples, one or more of the RESS 218-1 , 218-2, …, and 218-N include battery cells with different chemistry than remaining ones of the RESS 218-1 , 218-2, …, and 218-N.

The PIM 226-1 supplies power to one or more electric machines (or electric motors) 228-1. As can be appreciated, the HV buses 210-1, 210-2, …, and 210-N shown in FIG. 2 are merely examples for illustration purposes.

In FIG. 2B, a single OBCM 214 is shared by the HV buses 210-1, 210-2, …, and 210-N rather than each HV bus having a separate OBCM as in FIG. 2A. In some examples, the OBCMs are bidirectional to enable energy balancing by supplying energy from one of the RESS to the other RESS prior to DCFC. In some examples, an additional HV bus 213-3 may include a HV load 228 such as APM, ACEC, CEH, V2x, etc. instead of a PIM.

In some examples, the OBCMs are bidirectional to enable energy balancing by transferring power from one of the RESS to another one of the RESS. Bidirectional OBCMs can also be used to support vehicle to home (V2H), vehicle to vehicle (V2V), vehicle to load (V2L), and/or vehicle to anything (V2X) functionality. In other examples, the OBCMs are configured to supply power from one HV bus with a healthy RESS to the other HV buss with an unhealthy RESS.

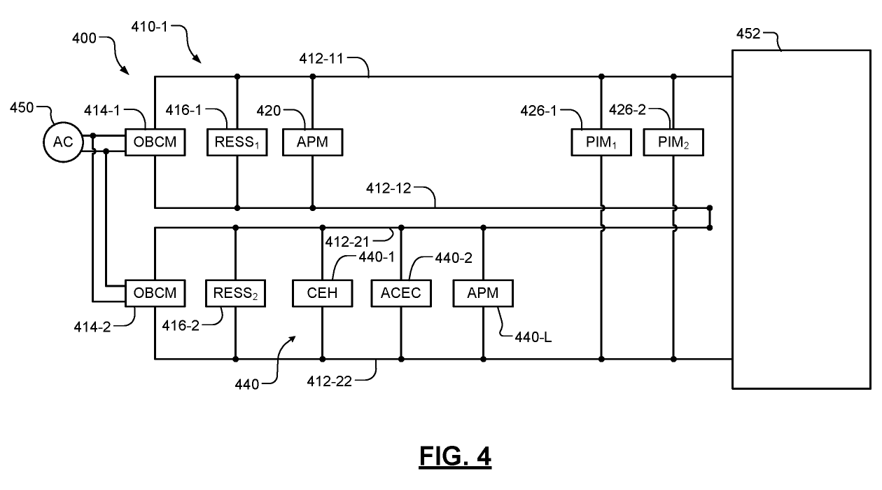

Referring now to FIGS. 3 and 4 are functional block diagrams of other examples of distributed high voltage bus and hybrid RESS architectures. In FIG. 3, a distributed high voltage bus and hybrid RESS architecture 300 includes HV buses 310-1 and 310-2. In this example, three HV buses are formed. A first HV bus is formed between first and second conductor at a voltage equal to RESS1. A second HV bus es formed between third and fourth conductor with a voltage equal to RESS2. A third HV bus is between first and fourth conductors with voltage equal to RESS1 + RESS2. While three HV buses are shown, additional HV buses can be used. Furthermore, example loads are connected to one or both HV buses. However, other configurations are possible.

The HV bus 310-1 includes an OBCM 314-1 connected between supply and reference conductors 312-11 and 312-12. A RESS 316-1 is connected between the supply and reference conductors 312-11 and 312-12. A PIM 326-1 (motor not shown) is connected between the supply and reference conductors 312-11 and 312-12.

The HV bus 310-2 includes an OBCM 314-2 connected between supply and reference conductors 312-21 and 312-22. A RESS 316-2 is connected between the supply and reference conductors 312-21 and 312-22. A PIM 326-2 is connected between the supply and reference conductors 312-21 and 312-22.

In some examples, a PIM 326-3 is connected across the supply and reference conductors 312-11 and 312-22. A switch box 340 includes one or more switches that connect the conductors of the HV buses 310-1 and 310-2 in various configurations to one or more DCFC plugs (e.g., two DCFC plugs 344-1 and 344-2 are shown). While two HV buses are shown, additional HV buses can be used. As can be appreciated, each HV bus can be associated with one or more loads.

In some examples, the switch box 340 is located inside of the vehicle. In other examples, the switch box 340 is located outside of the vehicle. In some examples, the switch box 340 is modular and variations are selected to provide different functionality. The HV buses can be operated at the same or different voltage levels. By having HV buses operating at different voltage levels, the loads can be fed with an optimum voltage (to eliminate voltage range proliferation).

Providing more than one HV bus allows the battery cells, modules, or packs for each of the RESS to be connected separately. For example, one RESS can be connected in the front of the vehicle and the other RESS can be connected in the rear of the vehicle. Furthermore, an individual RESS can be replaced in the event of a failure rather than replacing the RESS for the entire vehicle. In some examples, the switch box can be used to reconfigure the RESS to enable a limp home mode in the event that one or more of the RESS fail.

In some examples, the switch box 340 allows reconfiguration of the RESS in different configurations including series or parallel, multi-port charging (e.g., to double DCFC voltage) and/or charging of an individual RESS. The distributed high voltage bus and hybrid RESS architectures described herein provide increased flexibility by enabling different configurations by changing the switch box 340.

In FIG. 4, a distributed high voltage bus and hybrid RESS architecture 400 includes HV buses 410-1 and 410-2. The HV bus 410-1 includes an OBCM 414-1 connected between conductors 412-11 and 412-12 and to an AC source 450 during AC charging. A RESS 416-1 is connected between the conductors 412-11 and 412-12. An auxiliary power module (APM) 420 (e.g., supplying other loads) is connected between the conductors 412-11 and 412-12. The HV bus 410-2 includes an OBCM 414-2 connected between conductors 412-21 and 412-22. A RESS 416-2 is connected between the conductors 412-21 and 412-22. Other loads 440 (e.g., a coolant electric heater (CEH) 440-1, an air conditioning electric compressor (ACEC) 440-2, and an APM 440-L) are connected between the conductors 412-21 and 412-22.

In this example, the conductor 412-12 of the first HV bus 410-1 is connected to the conductor 412-21 of the second HV bus 410-2. PIM 426-1 and PIM 426-2 are connected between the conductors 412-11 and 412-22. A switch box 452 includes one or more switches to connect to the DCFC station in various configurations.

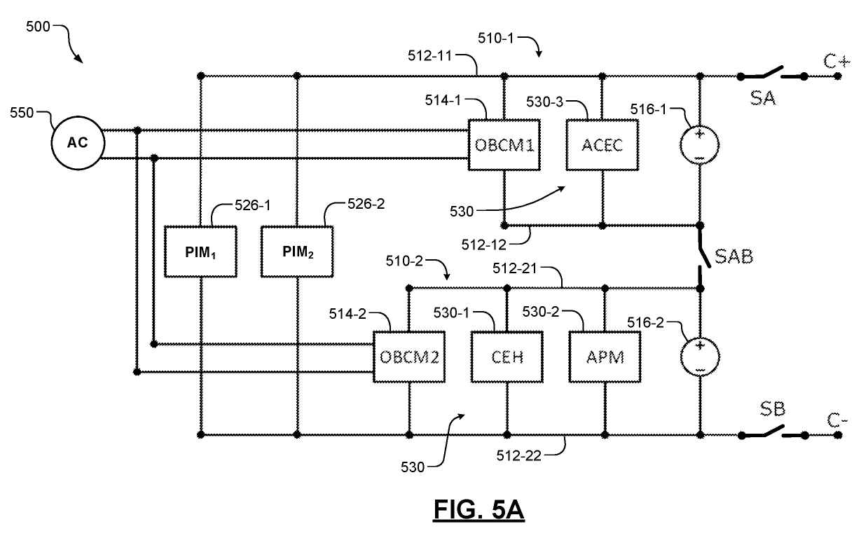

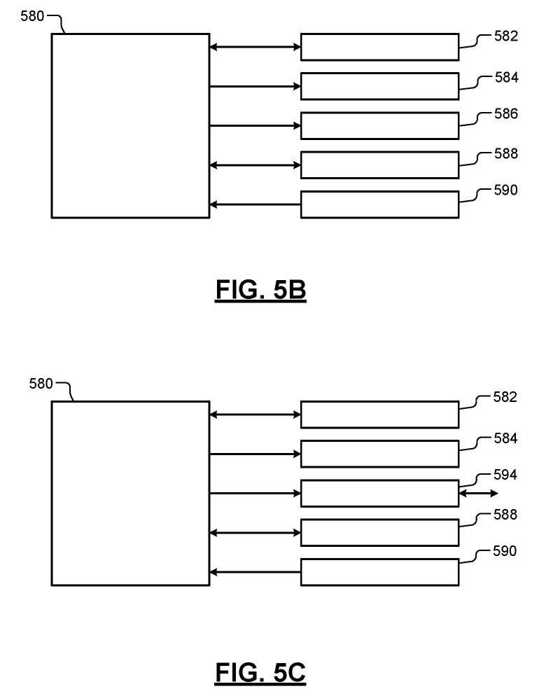

Referring now to FIGS. 5A-8 are functional block diagram of other examples of distributed high voltage bus and hybrid RESS architectures that can be paired with modular switch boxes. In FIG. 5A, the distributed high voltage bus and hybrid RESS architecture 500 includes HV buses 510-1 and 510-2. The HV bus 510-1 includes an OBCM 514-1 connected between conductors 512-11 and 512-12 and to an AC source 550 during AC charging. A RESS 516-1 is connected between the conductors 512-11 and 512-12. One or more loads 530 (e.g., an ACEC 530-3) is connected between the conductors 512-11 and 512-12.

The HV bus 510-2 includes an OBCM 514-2 connected between conductors 512-21 and 512-22. A RESS 516-2 is connected between the conductors 512-21 and 512-22. One or more loads 530 (such as a CEH 530-1 and/or an APM 530-2) is connected between the conductors 512-21 and 512-22. In some examples, PIM 526-1 and PIM 526-2 are connected between the conductors 512-11 and 512-22. A switch SA is connected between the conductor 512-11 and a DCFC terminals C+. A switch SB is connected between the conductor 512-22 and a DCFC terminals C-. A switch SAB is connected between the conductors 512-12 and 512-11.

In FIG. 5B, a controller 580 is configured to control the OBCMs during AC charging, energy sharing, or energy rebalancing, the switches (e.g., switch SA, SB, and SAB described below), switches 586 in the switch box, and the PIMs 588. The controller 580 received outputs of one or more sensors 590 such as voltage and current sensors. In FIG. 5C, the controller 580 can output signals via an interface 594 to an external controller controlling the switches of the switch box in the case where the switch box is located externally. The external controller can be part of the switch box or the DCFC station.

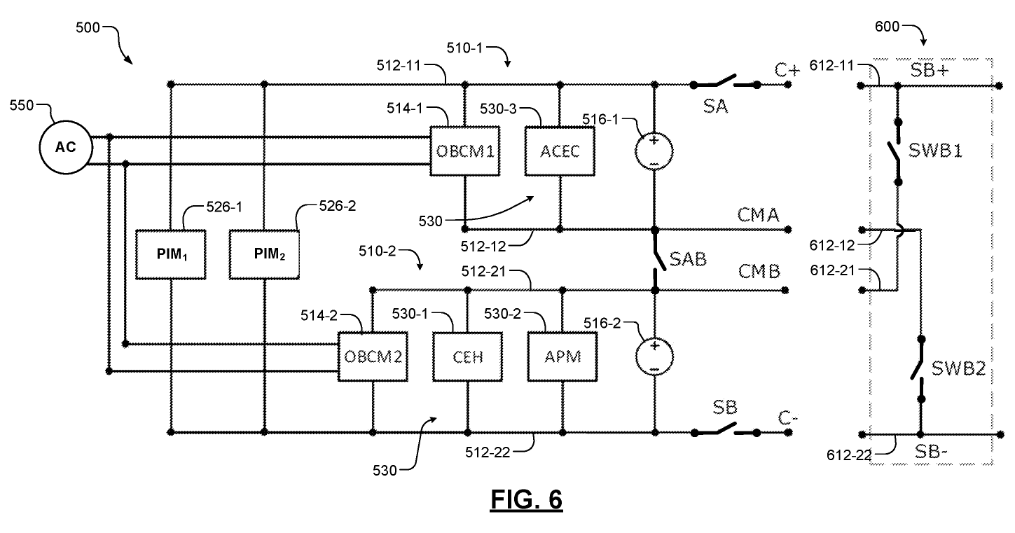

Examples of different switch boxes are shown in FIGS. 6 to 8. In FIG. 6, a switch box 600 includes conductors 612-11, 612-12, 612-21, and 612-22 that are connected to the conductors 512-11, 512-12, 512-21, and 512-22, respectively, of the HV buses 510-1 and 510-2. The conductors 612-11, 612-12, 612-21, and 612-22 are selectively connected to a DCFC station with a DCFC port and control signal port (to control the switches SWB1 and SWB2). The switch box 600 includes a switch SWB1 connected between the conductor 612-11 and 612-21 and a switch SWB2 connected between the conductor 612-12 and 612-22.

In this example, the switch box 600 provides two terminals for DCFC. The switch box 600 enables DCFC at a first voltage level (e.g., 400V). If one of the RESS is damaged, the switch box is configured to allow charging of the healthy RESS (and not the faulty RESS) by closing one of the switches SWB1 or SWB2 and opening the other one of the switches SWB2 or SWB1.

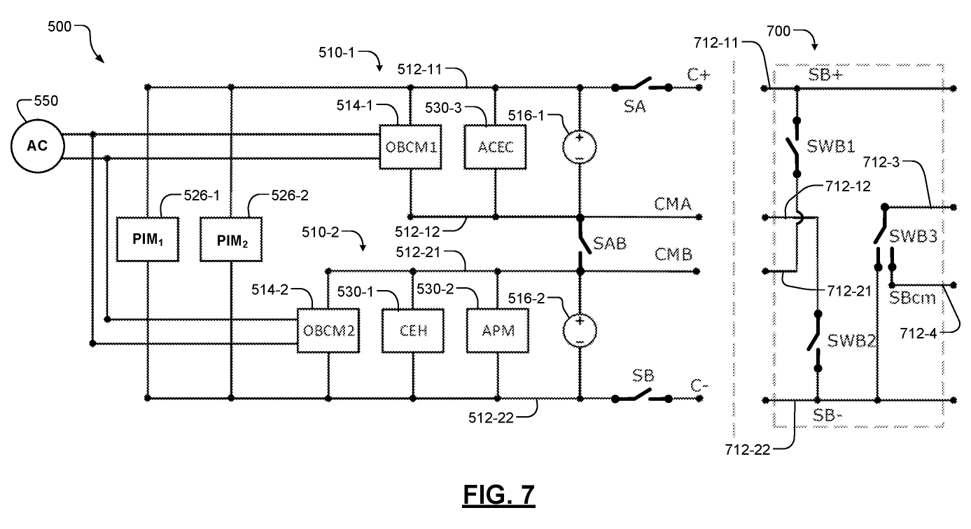

In FIG. 7, a switch box 700 includes conductors 712-11, 712-12, 712-21, and 712-22 that are connected to the conductors 512-11, 512-12, 512-21, and 512-22, respectively, of the HV buses 510-1 and 510-2. The switch box 700 includes a switch SWB1 connected between the conductor 712-11 and 712-21 A switch SWB2 is connected between the conductor 712-12 and 712-22. A switch SWB3 comprises a single pull double throw (SPDT) switch that selectively connects a conductor 712-3 to the conductor 712-22 or a conductor 712-4. The conductors 712-11, 712-3, 712-4, and 712-22 are selectively connected to a DCFC station.

In this example, the switch box 700 provides four terminals for DCFC. The switch box 700 can be configured as in FIG. 6 or to enable two port DCFC, which is the fastest charging approach currently available.

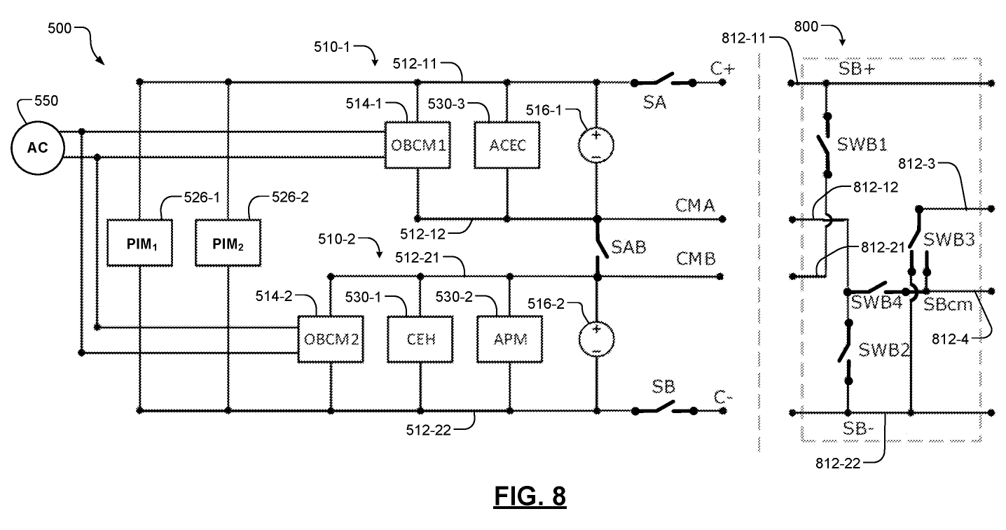

In FIG. 8, a switch box 800 includes conductors 812-11, 812-12, 812-21, and 812-22 that are connected to the conductors 512-11, 512-12, 512-21, and 512-22, respectively, of the HV buses 510-1 and 510-2. The switch box 800 includes a switch SWB1 connected between the conductor 812-11 and 812-21 A switch SWB2 is connected between the conductor 812-12 and 812-22. A switch SWB4 selectively connects a conductor 812-4 to the conductor 812-12. A switch SB3 selectively connects the conductor 812-3 to the conductor 812-22 or the conductor 812-4. The conductors 812-11, 812-3, 812-4, and 812-22 are selectively connected to a DCFC station.

In this example, the switch box 800 provides four terminals for DCFC. The switch box 700 can be configured as in FIG. 6, two port DCFC, or charging each RESS with a dedicated port without requiring energy balancing prior to charging.

Referring back to FIG. 5A, the switches SA and SB can be opened and the switch SAB can be closed to connect both RESS in series across the PIMs (e.g., 800V or another voltage level) while powering loads with one of the RESS (e.g., 400V or another voltage level).

The switches SA, SB, and SAB can be closed for charging at a DCFC at 800V. Prior to DCFC, energy (or state of charge (SOC)) balancing can be performed between two or more RESS prior to DCFC with energy sharing through the bidirectional OBCMs. This approach can be used by customers prior to a longer trip. If pre-balancing is not performed, the SOC of one RESS can be different than the other RESS after charging. Most customers use DCFC charge to a value less than full SOC (such as 80% SOC) and therefore there is low impact to customer satisfaction. If a higher SOC is desired when charging in this configuration, OBCM energy balancing can be performed or energy balancing can be performed through the switch box. However, the total charge time including energy balancing will be longer than usual.

The switches SA and SB can be closed and the switch SAB can be opened to charge both RESS at a lower DCFC voltage equal to the RESS voltage (e.g., 400V or another voltage level). The switch boxes 600, 700, and 800 in FIGS. 6-8, respectively, can be configured in a similar way.

Referring back to FIG. 6, either the switch SA or SB is closed and SAB is opened and the switch box 600 is configured to connect the DCFC to one of the RESS. For example, switch SA is opened, switch SAB is opened, switch SB is closed, SWB1 is closed, and SWB2 is opened to charge RESS 516-2. For example, switch SA is closed, switch SAB is opened, switch SB is opened, SWB1 is opened, and SWB2 is closed to charge RESS 516-1. The switch boxes 700 and 800 in FIGS. 7 and 8, respectively, can be configured in a similar way.

Referring back to FIG. 7, two port DCFC can be performed by closing switches SA, SB, and SAB, opening switches SWB1 and SWB2, and configuring switch SWB3 to connect the conductor 712-3 to the conductor 712-4. The switch box 800 can be configured in a similar way.

Referring back to FIG. 8, two port charging with separate connections to the RESS can be performed by closing switches SA, SB, and SAB, opening switches SWB1 and SWB2, and configuring switch SWB3 to connect the conductor 812-3 to the conductor 812-4.

As can be appreciated, while specific examples of HV loads are shown, other HV loads can be used. In some examples, the AC source can be replaced by a load and power can be supplied using the OBCMs to an external load.

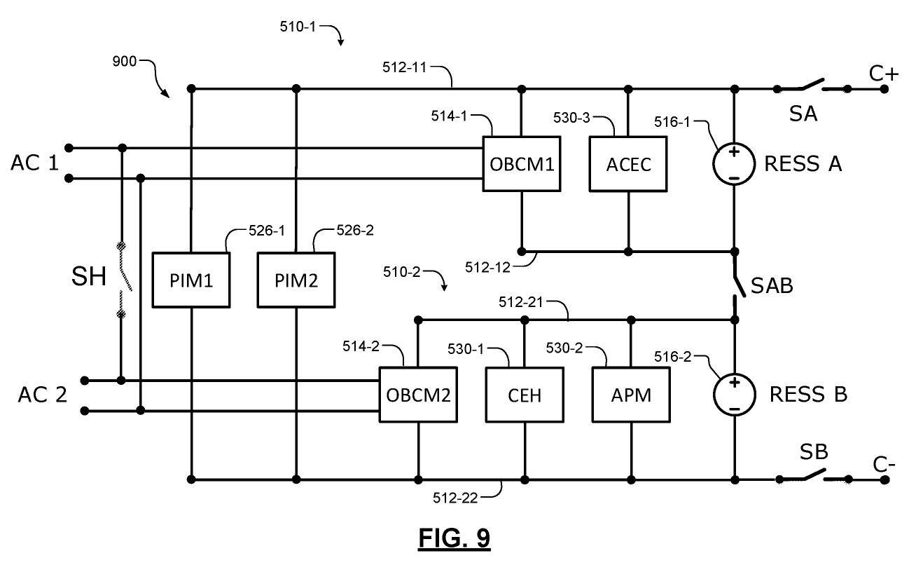

Referring now to FIG. 9, a distributed high voltage bus and hybrid RESS architecture 900 is shown for distributed home charging. A switch SH is ON when only one AC port or during energy sharing between the multiple busses. The switch SH is OFF when charging through multiple AC ports.

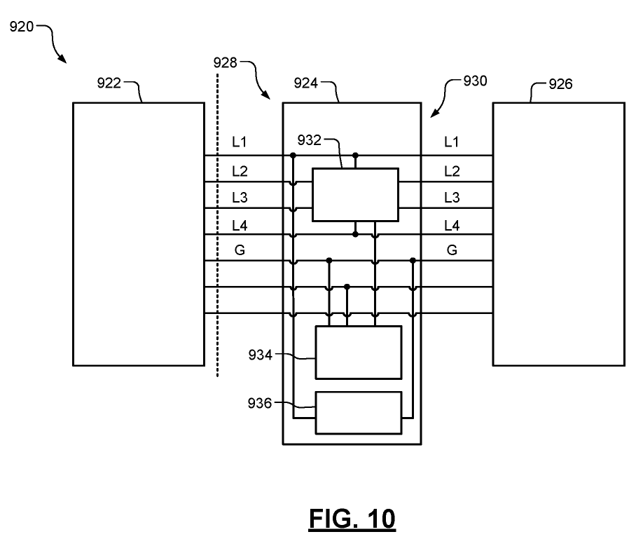

Referring now to FIG. 10, a vehicle 920 includes a vehicle charging port 922. A switch box 924 is removably connected to the vehicle charging port 922. A charger 926 supplying DC and/or AC power is removably connected to the switch box 924. The switch box 924 is a reconfigurable connector that includes a first port 928 removably connected to the vehicle charging port 922 and a second port 930 removably connected to the charger 926. As noted above, different types of switch boxes can be used in conjunction with switching between AC and DC charging from the same port.

In this example, the first port 928 includes conductors L1 L2, L3, and L4 corresponding to C+, CMA, CMB, and C- terminals (e.g., corresponding to FIG. 8). However, fewer terminals can be used (e.g., corresponding to FIG. 5A). The second port 930 includes at least two of the conductors L1 L2, L3, and L4 depending upon the configuration (L1 to L4 are shown). Additional conductors may include ground reference (G), control (Ctrl), or other data lines (Other). The control conductor Ctrl carries control data such as switch box configuration data for switches in the switch box 924 and/or switch box configuration data for the vehicle charging port (when either AC or DC voltage can be supplied from the charger).

The switch box 924 further includes a plurality of switches 932 (such as the switch configurations described above in FIGS. 6-8 or other switch configurations). The switch box 924 further includes a switch configuration circuit 934 configured to control states of the plurality of switches 932 in response to switch configuration data in the control data on the Ctrl conductor. The switch box 924 further includes a converter 936 configured to perform DC-DC and/or AC-DC power conversion to supply power from the charger 926 to the switch configuration circuit 934.

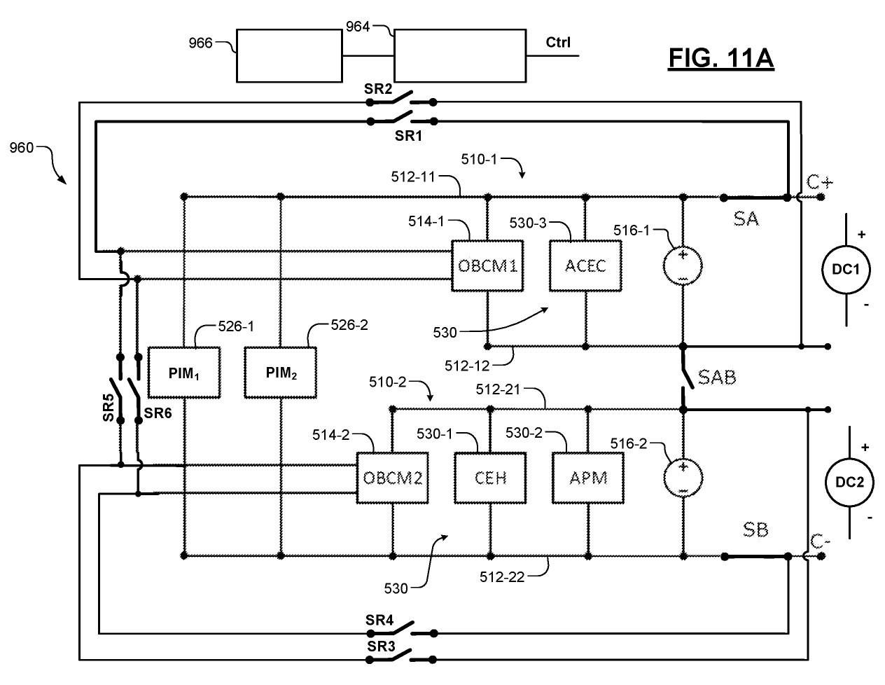

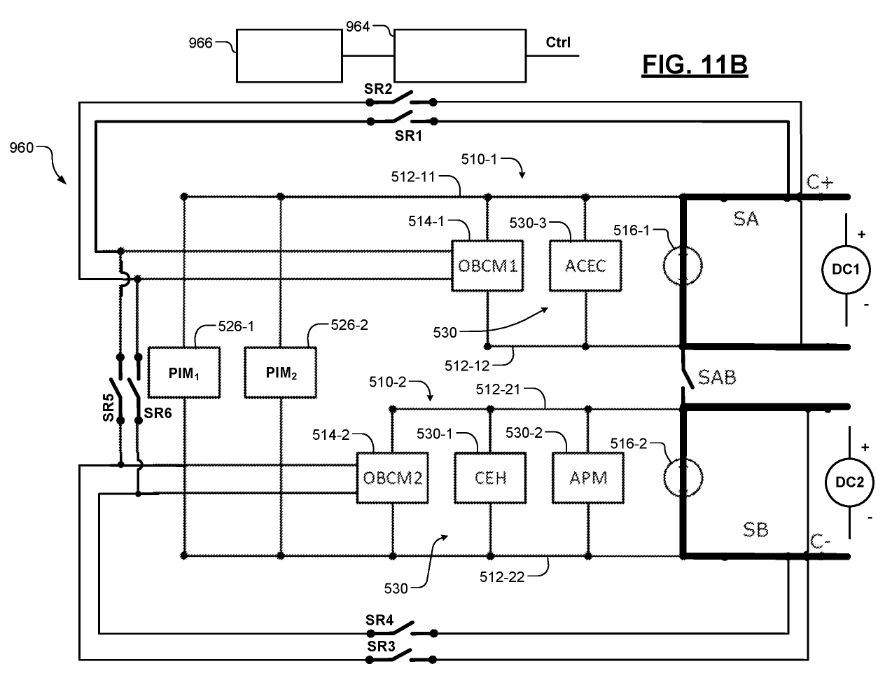

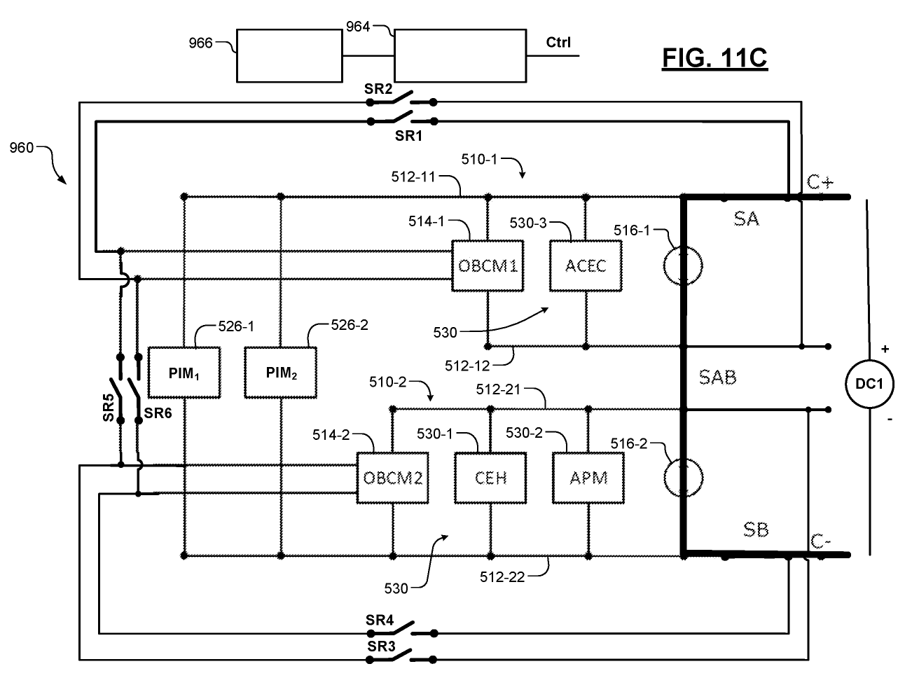

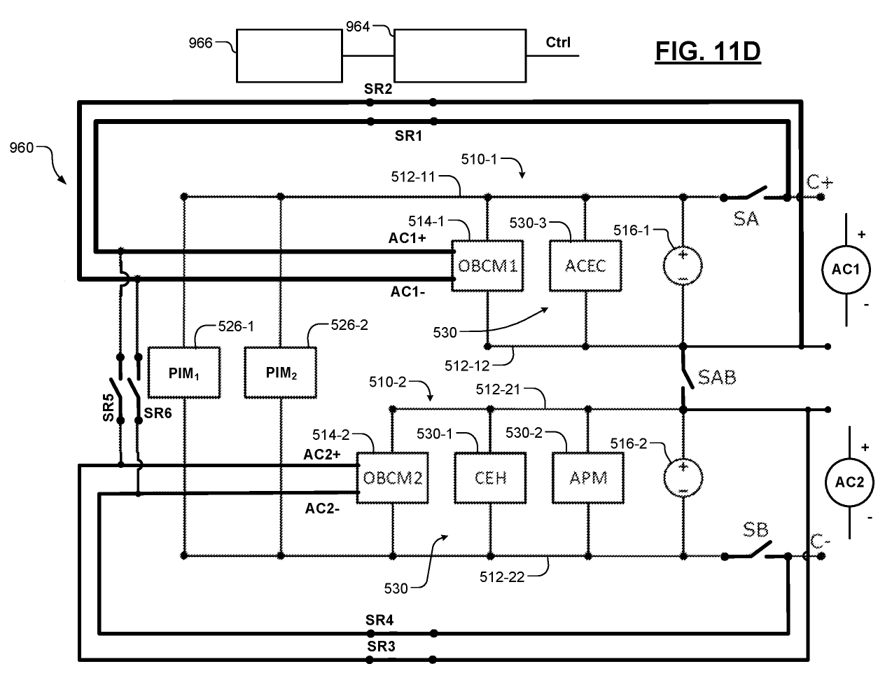

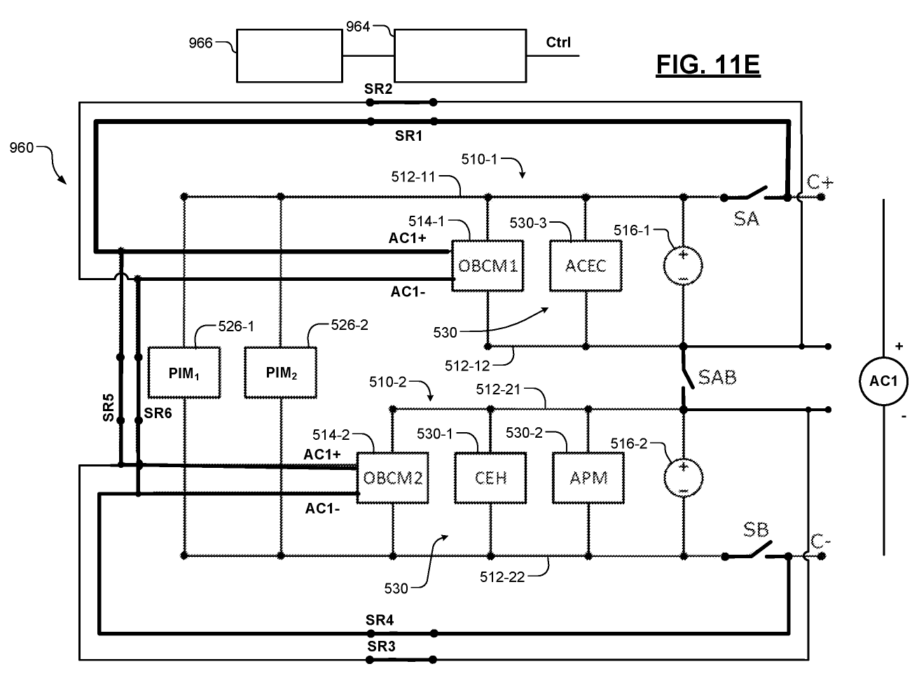

Referring now to FIG. 11A, in some examples, the vehicle 920 includes a switch configuration circuit 964 and a plurality of switches 966. This configuration allows the charger 926 to supply AC power from the charger 926 to an onboard charging module (OBCM) or DC power to first and second RESS 516-1 and 516-2 associated with first and second HV buses 510-1 and 510-2 using the same port connections. This configuration eliminates the need for separate ports for AC and DC chargers.

Additional switches SR1, SR2, …, and SR6 (in combination with the switches SA, SB, and SAB) allow connection of AC or DC sources from the charger 926. Switches SR1 and SR3 selectively connect the first and third conductors to the OBCM1 514-1 and the OBCM2 514-2, respectively. Switches SR2 and SR4 selectively connect the second and fourth conductors to the OBCM1 514-1 and the OBCM22 514-, respectively. Switch SR5 selectively connects the first and third conductors. Switch SR6 selectively connects the second and fourth conductors. The additional switches SR1, SR2, …, and SR6 are configured to connect either DC or AC power from the charger 926 to the OBCM 514-1 and/or the OBCM 514-2 in various combinations.

In FIG. 11B, the switches SAB and SR1, SR2, …, and SR6 are open and SA and SB are closed to supply DC power from DC sources DC1 and DC2 to the first RESS 516-1 and the second RESS 516-2, respectively.

In FIG. 11C, the switches SR1, SR2, …, and SR6 are open and SA, SAB, and SB are closed to supply DC power from DC source DC1 to the first RESS 516-1 and the second RESS 516-2.

In FIG. 11D, the switches SR1, SR2, …, and SR4 are closed and SA, SAB, SB, SR5, and SR6 are opened to supply AC power from AC sources AC1 and AC2 via the OBCM1 514-1 and OBCM2 514-2 to the first RESS 516-1 and the second RESS 516-2, respectively.

In FIG. 11E, the switches SR1, SR2, …, and SR6 are closed and SA, SAB, and SB are opened to supply AC power from AC source AC1 via the OBCM1 514-1 and OBCM2 514-2 to the first RESS 516-1 and the second RESS 516-2, respectively.

Additional functionality is provided by the switch box 924 as described above. Combining the additional switches SR1, SR2, …, and SR6 with the switch box 924 provides increased flexibility and charging features. As can be appreciated, not all of the configurations are shown.

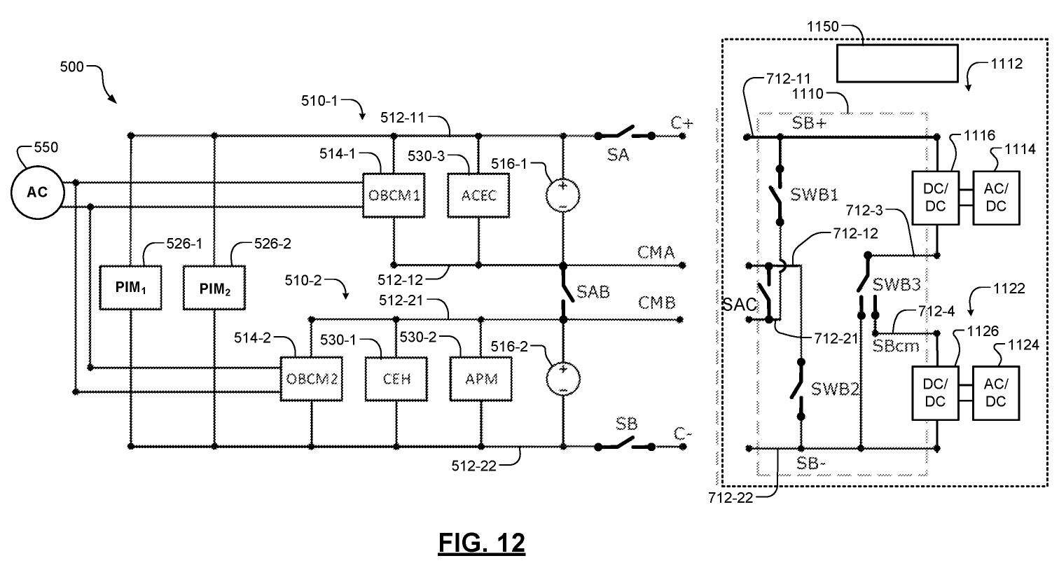

Referring now to FIG. 12, a switch box 1110 (e.g., similar to the switch box 700 in FIG. 7) is integrated with a DCFC 1112. The DCFC 1112 includes AC/DC converters 1114 and 1124 configured to perform AC/DC conversion. The AC/DC converters 1114 and 1124 are connected to an AC source such as a utility. In some examples, the AC/DC converters 1114 1124 are connected directly to the switch box 1110. In some examples, the AC/DC converters 1114 and 1124 are configured to perform AC to DC conversion. In some examples, the AC/DC converters 1114 and 1124 include an isolation circuit such as a transformer (not shown).

In other examples, DC/DC converters 1116 and 1126 are configured to convert from one DC level to another. In some examples, the DC/DC converters 1116 and 1126 include isolation circuits such as transformers (not shown). In some examples, the switch box 1110 further includes a switch SAC configured to connect the second conductor 712-12 to the third conductor 712-21. The switch SAB in the vehicle can be included or omitted. The switch box 1110 allows one DCFC or two DCFCs to be connected to two ports on the vehicle (each including two conductors for connecting power) or a single port (including four conductors for connecting power). A switch configuration circuit 1150 is configured to control the switches of the switch box 1110.

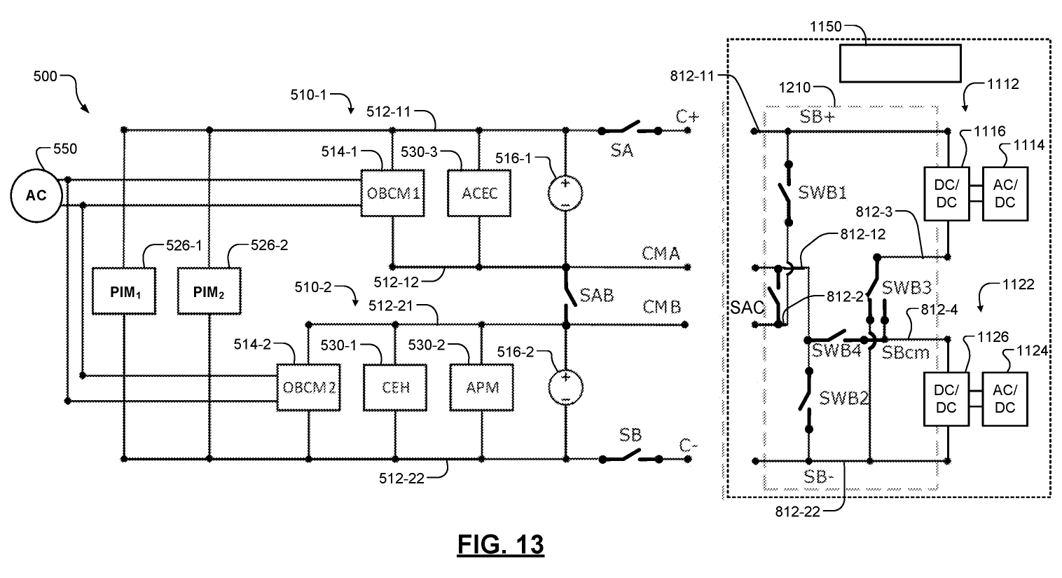

Referring now to FIG. 13, a switch box 1210 (e.g., similar to the switch box 800 in FIG. 8) is integrated with a DCFC 1112. The DCFC 1112 includes the AC/DC converters 1114 and 1124 configured to perform AC/DC conversion. The AC/DC converters 1114 and 1124 are connected to the AC source such as a utility. In some examples, the AC/DC converters 1114 1124 are connected directly to the switch box 1210. In some examples, the AC/DC converters 1114 and 1124 are configured to perform AC to DC conversion. In some examples, the AC/DC converters 1114 and 1124 include an isolation circuit such as a transformer (not shown).

In other examples, DC/DC converters 1116 and 1126 are configured to convert from one DC level to another. In some examples, the DC/DC converters 1116 and 1126 include isolation circuits such as transformers (not shown). In some examples, the switch box 1210 further includes a switch SAC configured to connect the second conductor 712-12 to the third conductor 712-21. The switch SAB in the vehicle can be included or omitted. The switch box 1210 allows one DCFC or two DCFCs to be connected to two ports on the vehicle (each including two conductors for connecting power) or a single port (including four conductors for connecting power).

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

In this application, including the definitions below, the term “module” or the term “controller” may be replaced with the term “circuit.” The term “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

The term code, as used above, may include software, firmware, and/or microcode, and may refer to programs, routines, functions, classes, data structures, and/or objects. The term shared processor circuit encompasses a single processor circuit that executes some or all code from multiple modules. The term group processor circuit encompasses a processor circuit that, in combination with additional processor circuits, executes some or all code from one or more modules. References to multiple processor circuits encompass multiple processor circuits on discrete dies, multiple processor circuits on a single die, multiple cores of a single processor circuit, multiple threads of a single processor circuit, or a combination of the above. The term shared memory circuit encompasses a single memory circuit that stores some or all code from multiple modules. The term group memory circuit encompasses a memory circuit that, in combination with additional memories, stores some or all code from one or more modules.

The term memory circuit is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general purpose computer to execute one or more particular functions embodied in computer programs. The functional blocks, flowchart components, and other elements described above serve as software specifications, which can be translated into the computer programs by the routine work of a skilled technician or programmer.

The computer programs include processor-executable instructions that are stored on at least one non-transitory, tangible computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation) (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Swift, Haskell, Go, SQL, R, Lisp, Java®, Fortran, Perl, Pascal, Curl, OCaml, Javascript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

What is claimed is:

1. A switch box comprising:
a first port removably connected to a charging port of a vehicle;
a second port removably connected to a charger;
first ends of a first conductor, a second conductor, a third conductor, and a fourth conductor arranged in the first port;
second ends of the first conductor and the fourth conductor arranged in the second port;
a first switch configured to selectively connect the first conductor to the third conductor;
a second switch configured to selectively connect the second conductor to the fourth conductor; and
a switch configuration circuit configured to receive switch configuration data from at least one of the vehicle and the charger and to control states of the first switch and the second switch in response to the switch configuration data.

2. The switch box of claim 1, further comprising:
a third switch including:
a first terminal connected to a first end of a fifth conductor, wherein the fifth conductor includes a second end in the second port;
a second terminal connected to a first end of a sixth conductor, wherein the sixth conductor includes a second end in the second port; and
a third terminal connected to the fourth conductor,
wherein the third switch is configured to selectively connect the first terminal of the third switch one of the second terminal of the third switch and the third terminal of the third switch.

3. The switch box of claim 2, wherein the switch configuration circuit is configured to control a state of the third switch in response to the switch configuration data.

4. The switch box of claim 3, further comprising a control conductor including a first end arranged in the first port and a second end arranged in the second port and configured to supply the switch configuration data to the switch configuration circuit.

5. The switch box of claim 4, further comprising:
a fourth switch including:
a first terminal connected to the second conductor; and
a second terminal connected to the sixth conductor,
wherein the fourth switch is configured to selectively connect the first terminal of the fourth switch to the second terminal of the fourth switch.

6. The switch box of claim 5, wherein the switch configuration circuit is configured to control a state of the fourth switch in response to the switch configuration data.

7. The switch box of claim 2, further comprising a converter configured to supply power to the switch configuration circuit.

8. The switch box of claim 4, wherein:
a first end of a seventh conductor is arranged in the first port and a second end of the seventh conductor is arranged in the second port, and
the seventh conductor carries a reference potential.

9. A vehicle comprising:
the charging port,
the switch box of claim 5;
wherein the first port of the switch box is removably connected to the charging port;
a first HV bus selectively connected to the first and second conductors, a first rechargeable energy storage system (RESS) selectively connected between the first and second conductors, and a first load selectively connected between the first and second conductors;
a second HV bus selectively connected to the third and fourth conductors, a second RESS selectively connected between the third and fourth conductors, and a second load selectively connected between the third and fourth conductors;
an onboard charging module (OBCM) configured to charge at least one of the first RESS and the second RESS using an alternating current (AC);
a plurality of switches configured to selectively connect at least two of the first conductor, the second conductor, the third conductor, and the fourth conductor to the OBCM; and
a controller configured to control the plurality of switches in response to the switch configuration data.

10. The vehicle of claim 9, wherein:
the OBCM includes a first OBCM connected to the first RESS and a second OBCM connected to the second RESS, and
the plurality of switches is configured to selectively connect the first conductor and the second conductor to the first OBCM and the third conductor and the fourth conductor to the second OBCM.

11. A vehicle comprising:
a first HV bus selectively connected to a first conductor and a second conductor, a first rechargeable energy storage system (RESS) selectively connected between the first conductor and the second conductor, and a first load selectively connected between the first conductor and second conductor;
a second HV bus selectively connected to a third conductor and a fourth conductor, a second RESS selectively connected between the third and fourth conductors, and a second load selectively connected between the third conductor and the fourth conductor;
a first switch selectively connecting the first conductor to the third conductor;
a second switch selectively connecting the second conductor to the fourth conductor; and
a third switch including:
a first terminal connected to a first end of a fifth conductor;
a second terminal connected to a first end of a sixth conductor; and
a third terminal connected to the fourth conductor,
wherein the third switch is configured to selectively connect the first terminal of the third switch to one of the second terminal of the third switch and the third terminal of the third switch,
wherein the first conductor, the second conductor, the fifth conductor and the sixth conductor are configured to connect to a charger.

12. The vehicle of claim 11, further comprising a fourth switch including:
a first terminal connected to the second conductor; and
a second terminal connected to the sixth conductor,
wherein the fourth switch is configured to selectively connect the first terminal of the fourth switch to the second terminal of the fourth switch.

13. The vehicle of claim 11, further comprising a switch configuration circuit configured to receive switch configuration data and to control states of the first switch, the second switch, and the third switch based thereon.

14. The vehicle of claim 13, further comprising a converter configured to supply power to the switch configuration circuit.

15. The vehicle of claim 14, further comprising:
a seventh conductor carrying a reference potential for the switch configuration circuit; and
an eighth conductor carrying control signals including the switch configuration data for the switch configuration circuit.

16. The vehicle of claim 15, further comprising:
a plurality of switches configured to selectively connect at least two of the first conductor, the second conductor, the third conductor, and the fourth conductor to an onboard charging module (OBCM) connected to at least one of the first HV bus and the second HV bus; and
wherein the switch configuration circuit is configured to control the plurality of switches in response to the switch configuration data.

17. The vehicle of claim 16, wherein:
the OBCM includes a first OBCM connected to the first RESS and a second OBCM connected to the second RESS, and
the plurality of switches is configured to selectively connect the first conductor and the second conductor to the first OBCM and the third conductor and the fourth conductor to the second RESS.

18. A direct current fast charger (DCFC) for a vehicle, comprising:
a first conductor, a second conductor, a third conductor, a fourth conductor, a fifth conductor, and a sixth conductor,
wherein the first conductor, the second conductor, the third conductor, and the fourth conductor are selectively connected to the vehicle;
a first alternating current/direct current (AC/DC) converter configured to convert AC power to DC power output on the first conductor and the fifth conductor;
a second AC/DC converter configured to convert AC power to DC power output on the fourth conductor and the sixth conductor;
a first switch configured to selectively connect the first conductor to the third conductor;
a second switch configured to selectively connect the second conductor to the fourth conductor;
a third switch including:
a first terminal connected to the fifth conductor;
a second terminal connected to the sixth conductor; and
a third terminal connected to the fourth conductor,
wherein the third switch is configured to selectively connect the fifth conductor to one of the fourth conductor and the sixth conductor;
a fourth switch configured to connect the second conductor to the third conductor; and
a switch configuration circuit configured to control states of the first switch, the second switch, the third switch, and the fourth switch.

19. The DCFC of claim 18, further comprising a fifth switch configured to connect the second conductor to the sixth conductor.

20. The DCFC of claim 18, further comprising:
a first DC/DC converter connected between the first AC/DC converter and the first conductor and the fifth conductor; and
a second DC/DC converter connected between the second AC/DC converter and the fourth conductor and the sixth conductor.
